(19) United States
(12) Patent Application Publication
(10) Pub. No.: US 2013/0112015 A1
(43) Pub. Date: May 9, 2013

(54) TIP FOR PIPETTING DEVICE INCLUDING A PART CAPABLE OF PROTECTING SAID DEVICE

(71) Applicant: Frederic Foucault, Amberieu en Bugey (FR)

(72) Inventor: Frederic Foucault, Amberieu en Bugey (FR)

(73) Assignee: BIOMERIEUX, Marcy L'Etoile (FR)

(21) Appl. No.: 13/810,951

(22) PCT Filed: Jul. 27, 2011
(86) PCT No.: PCT/FR2011/051810

§ 371 Date: Jan. 18, 2013

(30) Foreign Application Priority Data
Aug. 2, 2010 (FR) 1056384

(51) Int. Cl. B01L 3/02

(52) U.S. Cl. CPC B01L 3/021
USPC 73/864.01

(57) ABSTRACT

A tip capable of being fitted onto the body of a device for pipetting a liquid including a distal part intended for receiving the liquid sampled by the pipetting device, said distal part having a free distal end via which the liquid is aspirated and discharged, a middle part, joined to the distal part, intended to come into contact, via its free proximal end, with the body of said pipetting device and make it possible for said tip to be fixed on said body, a proximal part joined to the middle part and passed through by the body of said pipetting device when said tip is fitted on said body, said proximal part being intended for protecting said body and preventing any contact between the pipetting device and the liquid, said tip being characterized in that the proximal part is not in contact with the body of the pipetting device.

The technical field of the present invention is that of devices intended for sampling or dispensing a volume Of liquid inside a container. More particularly, the present invention relates to a skirted pipette cone, particularly made a injection-moulded plastic, intended to be fitted onto a pipetting device and to prevent the contamination of said device by the sampled or dispensed liquid.

In biological analysis systems, in particular in vitro diagnosis, the handling of different types of liquid is common: biological liquids, such as whole blood, serum, urine, cerebrospinal liquid or joint liquids or reagents. This handling consists in aspirating these liquids from a. source container and discharging them into a destination container, by means of an automatic pipetting device, an integral part of the biological analysis system. The pipetting device is often employed combined with a disposable single-use tip which is in the shape of a cone.

The containers used are generally flasks or tubes, which can be in different shapes and have different capacities. Certain containers thus have significant heights. This is the case with certain standardised tubes used in biological analysis systems, which are also called secondary tubes. This significant height presents a particular disadvantage which is that when the volume of liquid contained in the container is small, it is necessary to dip the disposable tip positioned at the end of the pipetting device down to the bottom of the container. Now, the disposable tips have a length which is often much less than the height of the containers. It then follows that the pipetting device also enters into the container. The risk of said pipetting device being contaminated through contact with the container is then substantial, particularly if it is off-centre. The use of the caps positioned permanently on the containers, such as the caps made of material which is based on natural or synthetic rubber, commonly called septums or caps of the “cross-slit valves” type, again increases the risk of contamination of the pipetting device insofar as the disposable tip and the pipetting, device passes through the cap to access the interior of the container. The pipetting device can therefore be contaminated by the liquid potentially present on the cap. In the same way, a sample can be contaminated by a sample previously aspirated and/or discharged by the pipetting device.

A solution to this problem can consist in using containers of lesser height, such that only the disposable tip enters inside the container, even when it is necessary to take a sample at the bottom of the latter. However, such containers have a limited volume which may not be compatible with the volume of liquid Which has to be transferred into these containers. It is then necessary to provide containers of different heights, which gives use to an additional cost for the user and reduces the consumer convenience.

Another solution would consist in compensating for the loss of height of the container, by a greater width or diameter. There is then the problem of the bulk of the container. In fact, if the container is bulkier, it is less easy to position in a biological analysis system, and at the very least, the number of containers positionable in the system is dramatically reduced.

A final solution would consist in using tips with a larger volumic capacity. These tips are generally longer and are therefore able to make it possible to sample a quantity of liquid at the bottom of a container without risking the pipetting device coining into contact with said container or the cap positioned on said container. The principal problem associated with the use of tips with a large volumic capacity is that they are not suitable for pipetting small volumes of liquid and thus generate errors in the pipetted volume which are likely to distort the analysis results. This is directly linked to the intrinsic precision of said tip.

It emerges from this state of the art that there is no tip capable of being positioned on a pipetting device and of making it possible to prevent said pipetting device from being contaminated by contact with the container into which it is dipped to aspirate or discharge a liquid.

The objectives of the present invention are therefore to address these deficiencies by proposing a tip which is of simple design, easy to produce, allowing a pipetting device to sample or discharge, with precision, a fraction of liquid at the bottom of a container, without risking the pipetting device being contaminated during this operation or itself contaminating the sample.

These objectives amongst others are achieved by the present invention which primarily relates to a tip capable of being fitted onto the body of it device for pipetting a liquid comprising:
a) a distal part intended for receiving the liquid sampled by the pipetting device, said distal part having a free distal end via which the liquid is aspirated and discharged,
b) a middle part, joined to the distal part, intended to come into contact, via its free proximal end, with the body of said pipetting device and make it possible for said tip to be fixed on said body,
c) a proximal part joined to the middle part and passed through by the body of said pipetting device when said tip is fixed on said body, said proximal part being intended for protecting said body and preventing any contact between the pipetting device and the liquid,
   the proximal part (16) not being in contact with the body of the pipetting device (26).

According to a particular embodiment, the overall shape of the tip according to the invention is substantially conical.

According to another particular embodiment, the tip according to the invention is made of a single material.

According to an alternative embodiment, the tip according to the invention is made of several materials.

The material(s) of which it is made are from the group of polyolefins, comprising amongst others polypropylenes, polyethylenes, styrene/butadiene copolymers.

Advantageously, the tip can be made entirely or in part from a material capable of conducting an electric current. Such a material can be, for example, a polymer from the class of polyolefins and charged by conducting particles such as carbon black.

Certain tips include filters, in order to protect the pipetting device from contaminant aerosols. Said tip is capable of permitting the use of such filters.

According to another particular embodiment, all or part of the inner wall includes a surface treatment capable of improving the pipetting precision.

Advantageously, the tip according to the invention is obtained by injection moulding.

Another object of the present invention relates to a pipetting device including a tip according to the invention.

Another object of the present invention relates to a biological analysis system including a pipetting device according to the invention.

The aims and advantages of the present invention will be better understood in light of the following detailed description, which by no means limits the invention, with reference to the drawings in which:

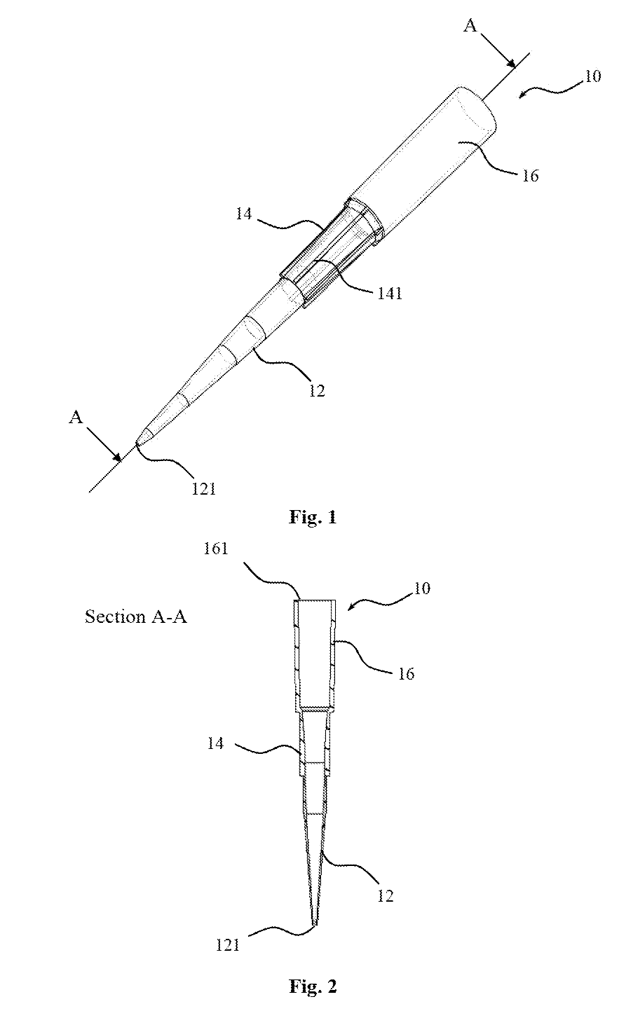

FIG. 1 shows a tip according to the present invention, in a perspective view.

FIG. 2 shows a tip according to the present invention, in a cross-sectional view along axis A-A obtained from FIG. 1.

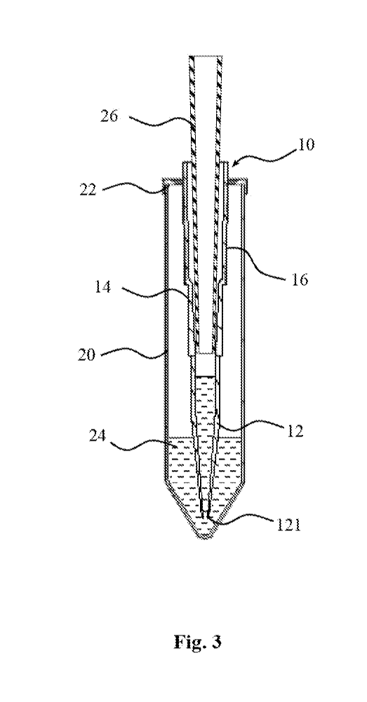

FIG. 3 shows a cross-sectional view of a tip placed onto a pipetting device during the step of sampling a liquid inside a container.

FIG. 1, the tip 10 according to the invention is shown in a perspective view. It is shown in cross-section along axis A-A, in FIG. 2. According to the embodiment shown. the tip 10 is generally conical in shape. It is nevertheless quite possible to envisage the tip 10 according to the invention being of a different shape. It is constituted of three distinct parts. Firstly, a distal part 12 which is substantially conical in shape. This distal part 12 constitutes the zone for receiving the liquid. Indeed, during the aspiration of a fraction of liquid by a pipetting device (not shown in this figure), onto which the tip 10 according to the invention is fitted, the aspirated liquid is stored in the distal part 12. The entry of the liquid into the distal part 12 occurs via the free end 121. The distal part 12 is connected by its proximal end to a middle part 14, which is substantially tapered. The main function of this middle part 14 is to provide the attachment between the pipetting device and the tip 10, when this is fitted on said device. This is clearly shown in FIG. 3. At the distal part 14 are arranged ribs 141 which form a notched. ring, of which the primary function is to reinforce this part, but also to avoid excessive deformations, during the forcible insertion of the pipetting device, but also to allow the tip 10 to he held vertically in its holder. Finally, the tip 10 includes a proximal part 16, connected to the middle part by its distal end. The proximal end 161 is free and allows the pipetting device to enter the tip 10. The primary function of the proximal part 16 is to protect the body of the pipetting device against any contact with the liquid to be sampled. This part can thus be referred to as a skirt part 16. This part 16 does not necessarily have the function of enabling attachment between the pipetting device and the tip, insofar as the end of the body of the pipetting device is supposed to access the middle part 14 and come into contact with the latter. The moulding and surface-state tolerances can be less rigorous for this part 16, which does not play a role. in the pipetting of the biological sample.

The proximal part 16 can have a variable length depending on the size of the tip 10. Thus for tips intended for sampling small volumes, it is beneficial to have a long proximal part. Conversely, for tips intended for sampling large volumes, the proximal part can be shorter in length, insofar as the tip already has substantial dimensions without the proximal part. Advantageously, the length of the proximal part 16 represents at least 15% (or even 20%) of the cumulative length of the middle 14 and distal 12 parts, on tips for sampling large volumes, e.g. 5 mL. It is quite possible to envisage: having, on tips for sampling small volumes (e.g. 0.1 to 10 μL), a proximal part of which the length is at least equal to the cumulative length of the middle 14 and distal 12 parts.

The tip 10 can be moulded from the materials usually used for moulding the tips of pipettes. The material can be, for example, a polyolefin-type polymer. The three parts of the tip can then be made of the same material insofar as this type of material is generally inexpensive, sterilisable and suitable for use to produce single-use products.

If it is desired that the tip also be a conductor of an electrical current, the cost of a conductive material can inhibit the use of one single material. In this case, only the distal and middle parts can be made of a conductive material insofar as they are involved in the electrical conduction between the liquid and the pipetting device. The proximal part, whose. sole function is to protect the pipetting device against any contact with the liquid can be made of a more economical non-conducting material such as a polyolefin. Such a multi-material tip can be made by bi-injection using a rotating mould, or by overmoulding.

The tip according to the invention can also benefit from a surface treatment of the inner wall in contact with the liquid, to improve the precision of the pipetting and of the sampled volume, and prevent the adsorption of elements forming the sample. Such a treatment can be performed by dipping, spraying, plasma treatment. In order to limit the cost of such a treatment it is advantageous to limit it to the distal 12 and middle 14 parts which are the only ones which come into contact with the liquid.

In FIG. 3, a container 20 of the analysis tube type can be seen. This container is substantially cylindrical, with a conical lower end. This tube includes in its upper part a cap. 22 through which the tip 10 enters into the tube 20. The tube 20 contains in its lower part a limited quantity of a liquid 24, of which a fraction is sampled by the pipetting device 26, shown in part in FIG. 3, in cross-section. This pipetting device can be an integral part of a biological analysis system (not shown) or can constitute an independent device.

As can be seen the body of the pipetting device 26 comes into contact with the middle part 14 of the tip 10, such that the body of the pipetting device and the tip 10 are attached to one another.

The proximal part 16 protects the body of the pipetting device 26 up to the outside of the tube 20, such that the pipetting device is entirely protected from any risk of contact with the liquid 24.

The distal part 12 of the tip 10, for its part, comes into contact with the liquid 24. During the step of aspiration by the pipetting device 26, the liquid enters inside the tip 10 through the free end 121 and is received in the distal part 12.

The tip 10 according to the invention thus combines the advantages of tips of small size and those of large size. Indeed, this tip constitutes a clever means of associating small-volume sampling with the volumetric precision of small tips and large dipping depth associated with the use of large-sized tips, whilst limiting the risks of contamination.

Furthermore, with such a tip, the centring tolerances between the container and the pipetting device can be relaxed, insofar as the contact between the container and the tip. does not have any harmful consequence.

The tip according to the invention is by no means limited in terms of its shape, its appearance, its size or the material of which it is made.

It can be used with all types of pipetting device, even those which comprise an ejection function.

If the ejection of the tip is performed by an external fork, this can bear on the upper end of the proximal part. In all cases, a potential and limited deformation of the latter has no effect insofar as this step is generally performed with the aim of disposing of said tip.

1. A tip capable of being fitted onto the body of a device for pipetting a liquid comprising:
a) a distal part intended for receiving the liquid sampled by the pipetting device, said distal part having a free distal end via which the liquid is aspirated and discharged,
b) a middle part, joined to the distal part, intended to come into contact, via its free proximal end, with the body of said pipetting device and make it possible for said tip to be fixed on said body,
c) a proximal part joined to the middle part and passed through by the body of said pipetting device when said tip is fitted on said body, said proximal part being intended for protecting said body and preventing any contact between the pipetting device and the liquid said tip being wherein the proximal part is not in contact with the body of the pipetting device.

2. The tip according to claim 1, having an overall shape which is substantially conical.

3. The tip according, to claim 1, being made of a single material.

4. The tip according to claim 1, being made of several materials.

5. The file tip according to claim 3 wherein the material(s) of which it is made are from the group comprising polyolefins, olefin block copolymers and biosourced polymers.

6. The tip according to claim 1, being made entirely or in part from a material capable of conducting an electric current, such as a polyolefin charged with conductive particles.

7. The tip according to claim 1 of which all or part of the inner wall includes a surface treatment capable of improving the pipetting precision.

8. The tip according to claim. 1, obtained by injection-moulding.

9. A pipetting device including a tip according to claim 1.

10. A biological analysis system comprising a pipetting device according to claim 9.
